(19) United States
(12) Patent Application Publication
(10) Pub. No.: US 2007/0214095 A1
(43) Pub. Date: Sep. 13, 2007

(54) Monitoring and notification system and method

(75) Inventors: Kenneth L. Adams, Washington, DC (US); R. Bruce Holcomb, McLean, VA (US); Christopher H. Wood, Alexandria, VA (US)

Correspondence Address: DICKSTEIN SHAPIRO LLP, 1825 EYE STREET NW, Washington, DC, 20006-5403, US

(73) Assignee: Dickstein Shapiro Morin & Oshinsky LLP

(21) Appl. No.: 11/373,233

(22) Filed: Mar. 13, 2006

(51) Int. Cl. G06Q 10/00; G06Q 30/00; H04L 9/00; H04K 1/00

(52) U.S. Cl. 705/80; 705/1

(57) ABSTRACT

The present invention provides a method and system for monitoring a plurality of sources meeting predetermined criteria and providing a user the data meeting the criteria. The method and system are particularly suited for monitoring sources potentially containing information related to class actions and providing the user with data related to class actions.

### FIELD OF THE INVENTION

This invention relates generally to providing monitoring and notification services and more particularly to providing a comprehensive, up-to-date, and easily accessible method and system for monitoring legal issues or cases, such as class actions, and notification of related deadlines via a computer network.

### DISCUSSION OF THE RELATED ART

Class action lawsuits are a way for similarly situated individuals and entities to seek legal redress. Class actions often are filed by a single plaintiff on behalf of itself and others. The other members of the purported class may not be aware that the litigation exists. The presiding court will determine whether the plaintiff represents a certifiable “class” of individuals and/or entities and what, specifically, defines the class. A class can be certified for purposes of litigation and settlement. For example, a class may be defined as anyone who purchased products from the defendant during a specified period of time.

Once a litigation or settlement class is approved, the court directs the plaintiff to provide notice to all members of the class concerning their legal rights as a class member at that juncture of the proceedings. Multiple notices can be mailed to class members over the course of a class action lawsuit. The first notice is designed generally to inform entities of their membership in a class and ability to “opt-out” or exclude themselves from the class. Additional notices may be used to inform class members of various other developments affecting the interests of class members, such as the dates by which objections to settlements must be filed and proofs of claims must be submitted, which are mechanisms employed to allocate and distribute settlement funds among class members. Missing any of the court established deadlines can irrevocably alter a class member's rights.

As it can be difficult to initially determine who or what entity is a class member, the type of notice given may vary depending on the circumstances of the case. For example, the court may determine that rather than mailing notices to all customers of a defendant, notice would be more effectively disseminated by simply publishing the notice of the class action in those publications read by potential class members (e.g., local newspapers, industry publications, among others). As a result, many potential class members will often not be aware of the class action and will therefore not be able to adequately protect their rights.

For many companies, businesses, or even certain individuals, remaining informed about class actions can be difficult. Continually monitoring publications and mailings for notices of class actions is burdensome. Additionally, even if a business, company, or individual receives notice of a class action, it can be time consuming to determine whether or not the particular entity or individual qualifies as a class member. As class membership is often determined by whether or not the company purchased certain products or services from the defendant during a specific time period, the company may be required to comb through its records every time it receives notice of a class action.

What is needed is a system and method for monitoring and notifying entities and/or individuals of class actions and deadlines related to class actions.

### BRIEF SUMMARY OF THE INVENTION

The present invention provides a method and system for monitoring a plurality of sources meeting predetermined criteria and providing a user data gather from the sources meeting the criteria. The method and system are particularly suited for monitoring sources containing information potentially related to class actions and providing the user with data related to class actions.

### BRIEF DESCRIPTION OF THE DRAWINGS

FIG. 1 is a block diagram illustrating a system according to an exemplary embodiment of the present invention;

FIG. 2 is flowchart representing the steps in a method for monitoring sources according to an embodiment of the present invention;

FIG. 3 shows a screen display of a user interface for inputting data according to an exemplary embodiment of the invention;

FIG. 4 is flowchart representing the steps in a method for gathering user specific information according to an embodiment of the present invention;

FIG. 5 is a flowchart representing the steps in a method according to an embodiment of the present invention;

FIG. 6 is an exemplary report of class actions provided to users according to the method of FIG. 5;

FIG. 7 is a block diagram illustrating the Web site of FIG. 1; and

FIGS. 8-12 show screen displays of various pages of the Web site illustrated in FIG. 7.

### DETAILED DESCRIPTION OF THE INVENTION

In the following description, reference is made to the accompanying drawings which will serve to illustrate exemplary embodiments of the invention. The description provides sufficient detail to enable those skilled in the art to practice the invention. Other embodiments may be used and various changes may be made without departing from the spirit and scope of the present invention. The scope of this invention is defined in part by the appended claims.

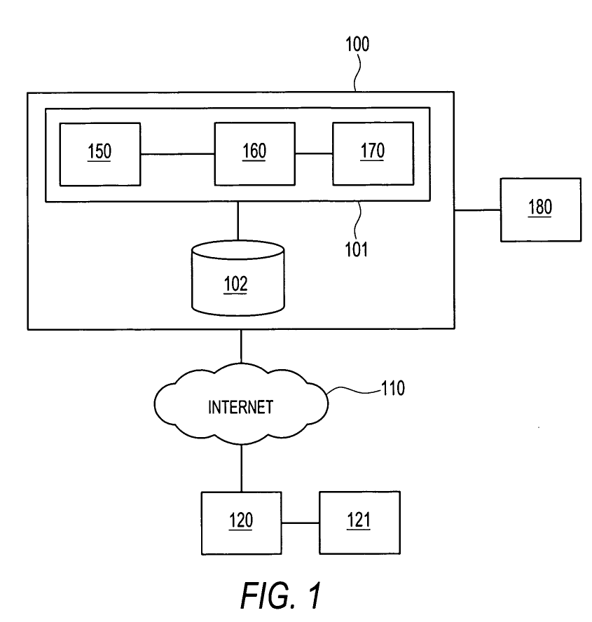

FIG. 1 is a block diagram of a system 100 according to an exemplary embodiment of the invention. The system 100 is described in connection with monitoring class actions and notifying users of relevant class actions and class action deadlines. The invention, however, is not so limited and can be used to monitor and keep users informed of other information. For example, the invention can be used with respect to bankruptcies or developments in state and/or national laws affecting the rights of and actions required by users (e.g., companies or other entities and individuals), such as laws related to human resources and employment policies, or any communications that are targeted to a class of individuals.

With the system 100, a user 121 can access information at a single location in an organized manner. In the illustrated embodiment, the system provides the user 121 with access to information regarding class actions at a single location, so that the user 121 is better informed of class actions that may affect the user's 121 rights. The user is thereby relieved of the burden of tracking and accessing multiple sources to obtain the information. Additionally, the system 100 can notify the user 121 of class actions likely to be of particular interest to the user 121 as well as new class actions and developments in existing class actions. Accordingly, the system 100 enables the user 121 to be better and more efficiently informed.

As shown in FIG. 1, system 100 includes at least one data storage device 102, such as a database, and at least one server 101. The system 100 also includes a monitoring module 170 and a notification module 160. The modules 160, 170 can be computer program applications running on the server 101. Alternatively, they can be installed as computer programs or other hardware logic devices or any processor-based platform, including a PDA, laptop or desktop microprocessor or a suitable communications device having processor capability (e.g., router, fax, among others), among others. The monitoring module 170 monitors various data sources and selects data to be saved to the database 102 according to a predetermined set of criteria as described in more detail below. The notification module 160 creates reports of the stored data and sends the report to users as described in more detail below. The system 100 is managed by a system manager 180 that configures and controls the components of the system 100.

A Web site 150 is also hosted by the server 101. Alternatively, the Web site 150 can be hosted by another server (not shown). The Web site 150 provides a user interface by which a user 121 can interact with the system 100 to access the data stored in the database 102. In the exemplified embodiment, the user 121 uses a client computer 120 to access the system via the Internet 110. Alternatively, the client computer 120 can be part of the same computer network as the system 100.

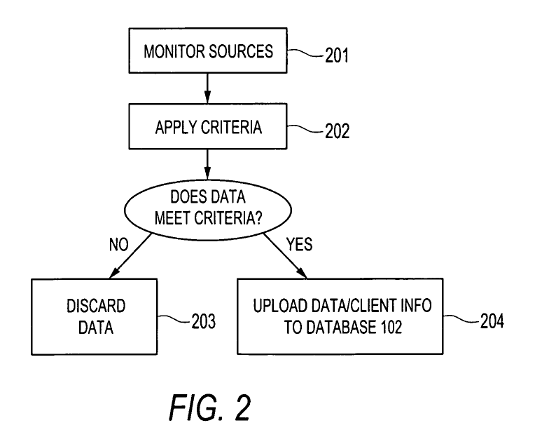

FIG. 2 is a flow chart depicting a method for gathering data for storage in the database 102. Steps 201-204 illustrate an exemplary method by which the monitoring module 170 gathers data to be stored in the database 102. A predetermined group of sources is monitored by the monitoring module 170 in step 201. Typically the sources are chosen by the system manager 180. In the illustrated embodiment, the monitored sources are Internet-based legal news publications related to class actions, on-line newspapers, claims administrators' Web sites, plaintiffs' bar Web sites and other Internet-based sources. Examples of web-based legal news publications include Mealey's Litigation Report: Class Actions, BNA: Class Action Litigation Report, Andrews: Class Action Litigation Reporter, and Class Action Law Monitor (Strafford Publishing). On-line newspapers, such as The New York Times, The Washington Post, The Wall Street Journal, Financial Times, and USA Today, are monitored. Claims administrators and their respective Web sites include The Garden City Group, Inc.: www.gardencitygroup.com, Gilardi & Co., LLC: www.gilardi.com, HR&S Claims Administrator: www.hrsclaimsadministration.com, Berdon & Co.: www.berdonllp.com, and Complete Claim Solutions: www.completeclaimsolutions.com. Certain pages of Web sites of the Plaintiffs' Bar are monitored, for example, Cohen, Milstein, Hausfeld & Toll: www.cmht.com (cmh&t news), Milberg Weiss Bershad & Schulman LLP: www.milbergweiss.com (current settlements), Hagens & Berman: www.hagens-berman.com (featured cases, recent developments), Lieff Cabraser Heimann & Bernstein: www.lieffcabraser.com (news, class notices, newsletter), Bernstein Litowitz Berger & Grossmann LLP: www.blbglaw.com (cases: recent settlements), Barrack Rodos & Bacine: www.barrack.com (antitrust: recent news; new and noteworthy). Other Internet-based sources, such as http://lawyersandsettlements.com, http://securities.stanford.com (current settlement news), www.LitWatch.com Google Alert (automated news tracking), www.Lexis.com (“Publisher” software automated news tracking), and www.securitiesclassaction.com also can be monitored. The invention, however, is not limited to these sources and other sources may also be monitored, such as, for example court Web sites, such as the Pacer litigation tracking system, among others. Additionally, manual monitoring can also be conducted to gather data from, for example, print or other non-electronic sources.

In step 202, a predetermined set of criteria is applied to the data within each source to extract data for storage on the database 102. In the exemplified embodiment, the data must meet the following criteria in order to be selected for storage on the database 102: 1) it must pertain to a class action and 2) the class action must involve a securities, antirust, or deceptive practices claim. Additional criteria can be applied for purposes of selecting data for storage on database 102. Additional criteria include, for example, a class action valued at a pre-defined dollar amount, e.g., more than $10 million; and/or a class action for which an event affecting the rights or status of class members has occurred. Examples of events affecting the status or rights of class members include, among others, court certification of a litigation or settlement class, and the entry of orders setting deadlines by which class members must exclude themselves from a class, file a written objection to a settlement, inform the court of its intention to attend a particular hearing, or submit a proof of claim.

There are multiple ways in which the criteria can be applied. In one embodiment, the criteria can be configured as search terms and applied to the data using a search capability of the monitoring module 170. The search capability can be a search engine internal to module 170, a third party engine or an external engine accessed by the module 170. For print sources, an electronic copy of the source can be created, for example, by a scanner or manually entered into a computer and stored on a computer readable medium. The electronic copy can be converted to a format in which the processor can recognize words. Alternatively, data to be stored on database 102 can be manually selected according to the criteria. Other possible methods for applying criteria include using data mining techniques known in the art.

If the data does not meet the criteria, it is discarded in step 203. If data does meet the criteria, it is uploaded to the database 102 in step 204. Data can be uploaded to the database in any manner desired. In the illustrated embodiment, the monitoring module 170 allows data to be entered into an on-line form 301 via Web site 150. Each form is saved as a database record and contains pre-defined fields.

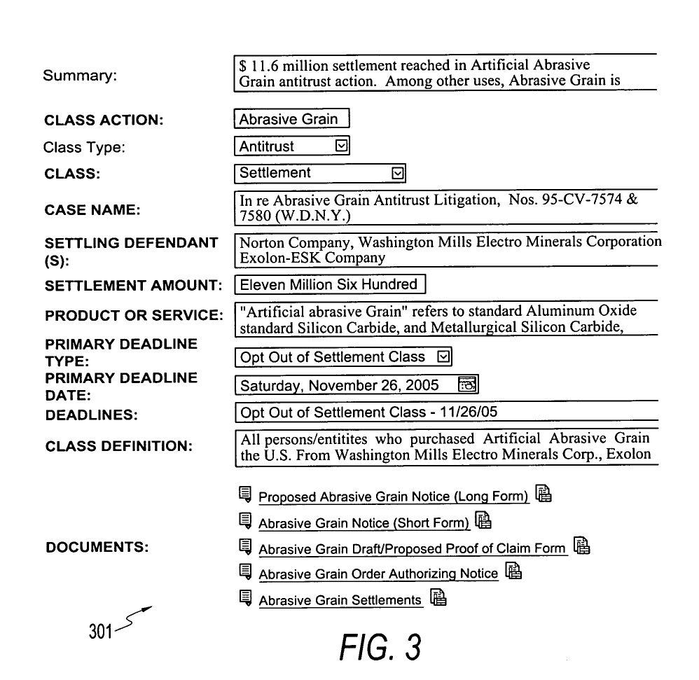

FIG. 3 is a screen shot of the user interface with the Web form 301. In the illustrated embodiment, each database record corresponds to a particular class action and contains the following fields: summary, class action short name, class action type, case name, defendant(s), settlement amount, product or service, deadline type(s), deadline date(s), class definition, and documents. The “documents” field allows for images or electronic copies of documents related to the respective class action (e.g., notices, proof of claim forms, settlements, among others) to be stored within the record. Other fields can be used and are chosen to accommodate the data desired for storage in the storage device 102.

Data can be entered into the Web form 301 manually. Alternatively, the monitoring module 170 can include a data mining functionality to at least partially automate the process for uploading data meeting the criteria into the database 102.

The database 102 can also include user specific data. In the illustrated embodiment, the user specific data is chosen so that the system 100 can determine what class action data would likely be of interest to a particular user 121. For example, the user specific information can be the goods and services purchased by the user 121 and the time period in which the user 121 made the purchases. By comparing goods and services referenced in a class action and identified by the monitoring module 170 with goods and services identified by the user 121, the system 100 can determine whether a particular class action is related to goods and services purchased by the user 121 as described in more detail below. Where a class action is related to goods and services purchased by the user 121, the class action is likely of interest to the user 121 primarily because the user 121 may be a member of the class in the monitored class action.

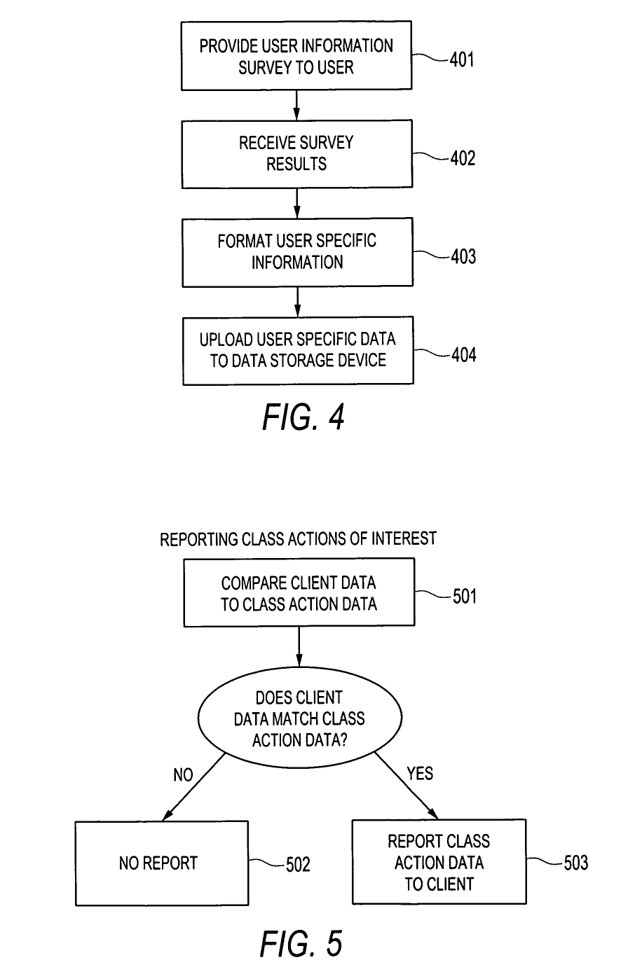

FIG. 4 illustrates an exemplary method for gathering user specific data and storing the data on the database 102. In step 401, the monitoring module forwards a user information survey to each user 121 by email. In the illustrated embodiment, the user information survey requests the user 121 to identify the products and services purchased by the user 121, the time period the products and services were purchased by the user 121, and the person(s) from whom the user 121 purchased the products and services.

Alternatively, the user information survey can be generated by the module 170 and printed and mailed, or communicated to each user 121 by any other known means. For example, the module 170 could send an email notice to each user 121 prompting the user to enter the Web site 150 and complete the user information survey as a Web form.

Once a user 121 completes a user information survey, the module 170 receives the completed survey in step 402. For this, the user 121 can forward the complete survey by email, mail or any other known means, for example, where the survey is a Web form, by indicating the survey is complete on the Web site 150.

In step 403, the module 170 formats the user specific data from the user information survey. For example, where the user information survey is in electronic format, data from specific locations or in specific fields of the survey can be automatically entered into predetermined fields of a database record. Additionally, the information on the survey can be checked for errors, such as missing information, among others. If missing information is detected, notice via the module 170 or otherwise (e.g., email) is sent.

Once the data from the user information survey is properly formatted, it is stored in the database 102 by the monitoring module 170 at step 404. Alternatively, the system manager 180 can manually enter the user specific data from the user information survey into the database 102.

The user specific data can be used to better enable a user 121 to identify class actions of interest from the class actions that are monitored by the monitoring module 170. FIG. 5 is a flow chart depicting an exemplary method for reporting class actions of interest to a user 121. In step 501, the notification module 160 compares user specific data to class action data stored in the database 102. The user data serves as criteria that are applied to the class action data. If class action data meets the criteria, the notification module 160 notifies the user 121 of the class action in step 503. If class action data does not meet the criteria, in step 502 the user 121 is not notified of the class action.

The notification module 160 is configured to report class actions of interest when the class actions are identified, or at pre-determined intervals of time, for example, weekly or bimonthly. Much like the monitoring module 170, the notification module 160 can be implemented as software or a hardware device. The intervals can be selected by the user 121 or the system manager 180. Additionally, the notification module 160 can instead be configured to report all class actions that are monitored by the monitoring module 170 to each user 121. In such a case, the method described in connection with FIG. 5 need not be performed. The notification module 160 can also be configured to report information related to the class actions to keep the user 121 informed of the progress and status of the class actions. For example, module 160 can be configured to report approaching deadlines in class actions of interest or all class actions monitored by the monitoring module 170; class actions detected by the monitoring module 170 within a specified time period; and/or developments (e.g., class certification, settlement, set deadlines, among others) occurring within a specified time period in class actions of interest or all class actions monitored by the monitoring module 170.

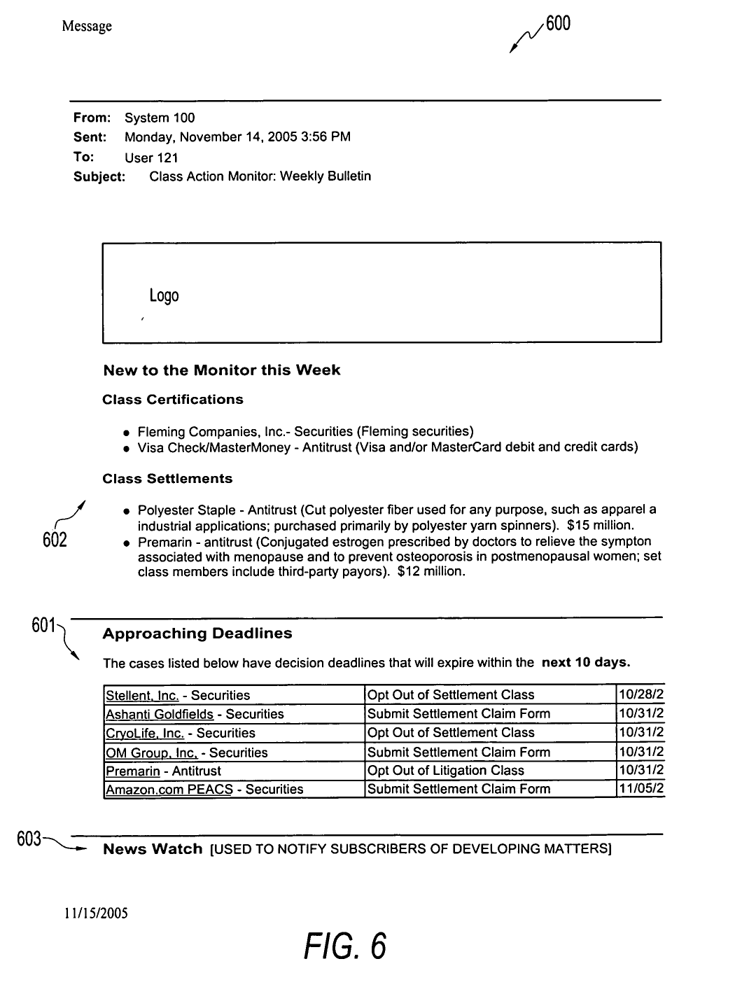

FIG. 6 is an example of a report 600 sent to a user 121 by the notification module 160. Reports can be sent to any type of entity, individual, law firm or even another web-site/database for further use or reference. The exemplified report 600 is an email report containing a list 601 of class actions previously identified approaching deadlines expiring within a set period of time from the date of the email report. The report also contains a list 602 of class actions with approaching deadlines not previously identified. The report 600 may also includes news 603 about developing class actions in which no deadlines affecting class members have occurred, or matters that may become class actions. The report 600 need not be an email and can be communicated to the user 121 in any suitable manner, for example, by sending a link to a web page containing the report 600, or by mailing a printed copy of the report 600, among others.

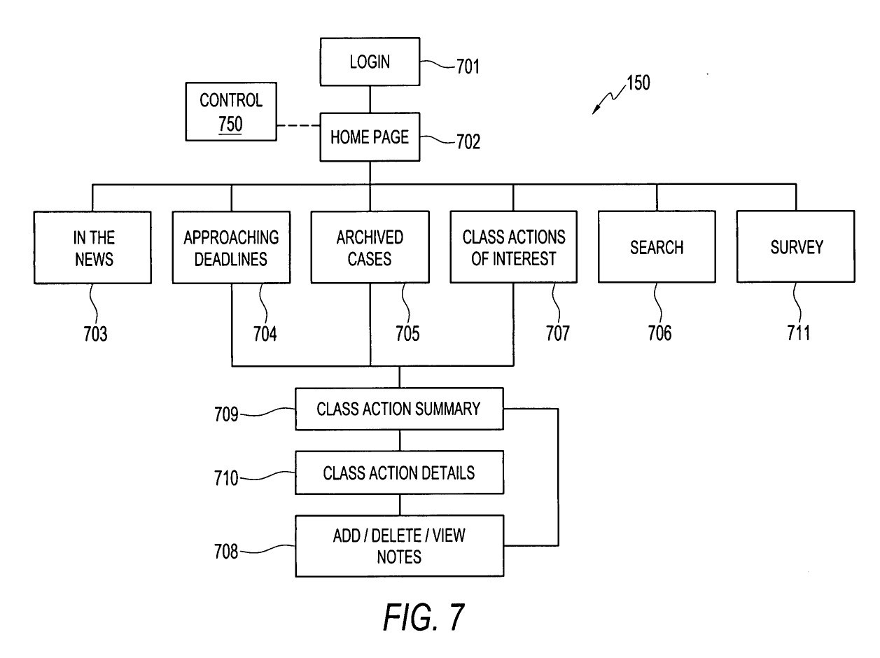

Users 121 (FIG. 1) can also access data stored in the database 102 via the internet 110 using the Web site 150. The Web site 150 provides at least one user interface that enables the user 121 to access data stored in the database 102 and, optionally, to input user specific data for storage to the database 102. Additionally, the Web site 150 includes a user interface that enables the system administrator 180 to edit or modify data in the storage device 102. FIG. 7 is a block diagram depicting the configuration of Web site 150 according to an exemplary embodiment of the invention.

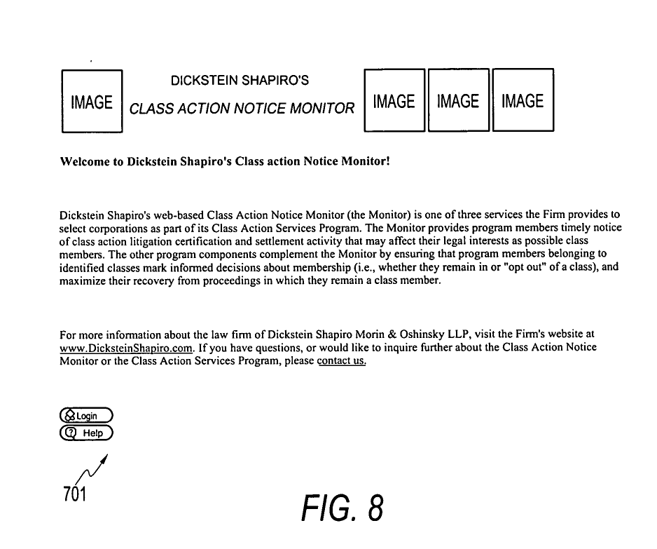

As shown in FIG. 7, the user 121 enters the Web site 150 through a login page 701. The user 121 can be required to enter valid login information to gain access to any other portions of the Web site 150. In one exemplary embodiment, the login information entered by the user 121 defines the data within the storage device 102 that the user 121 can access. A screen shot of an exemplary login page 701 is shown in FIG. 8.

The system manager 180 can also login to the Web site 150 via the login page 701. The system manager's login formation is configured to provide the system manager with access to the control segment 780. The control segment 780 provides a user interface through which the system manager 180 can, for example, edit data stored in the storage device 102, configure portions of the Web site 150, and otherwise control the content, format and functionality of the Web site 150.

Once a user 121 is logged into the site 150, the user is taken to a home page 702. From the home page 702, the user can navigate through segments of the Web site 150. Hyperlinks, or other means known in the art, can be used to allow the user 121 to navigate within the Web site 150.

From the home page 702, the user 121 can access current news regarding class actions or potential class actions on the in-the-news segment 703. The data contained in this segment is similar to that found in the news 603 section of the report 600 (FIG. 6). Thereby, the user 121 is informed of current news regarding class actions for which events affecting the rights of class members have yet to occur and can gain insight into matters that may develop into class actions. The user can also view approaching deadlines in class actions in segment 704, view class actions with matured or aged deadlines in the archived cases segment 705, search for class actions meeting specified criteria in the search segment 706, and view only the class actions of interest to the user 121 in segment 707. Optionally, the Web site 150 includes survey segment 711, which includes a user interface through which the user 121 can provide user specific data according to the method described above in connection with FIG. 4.

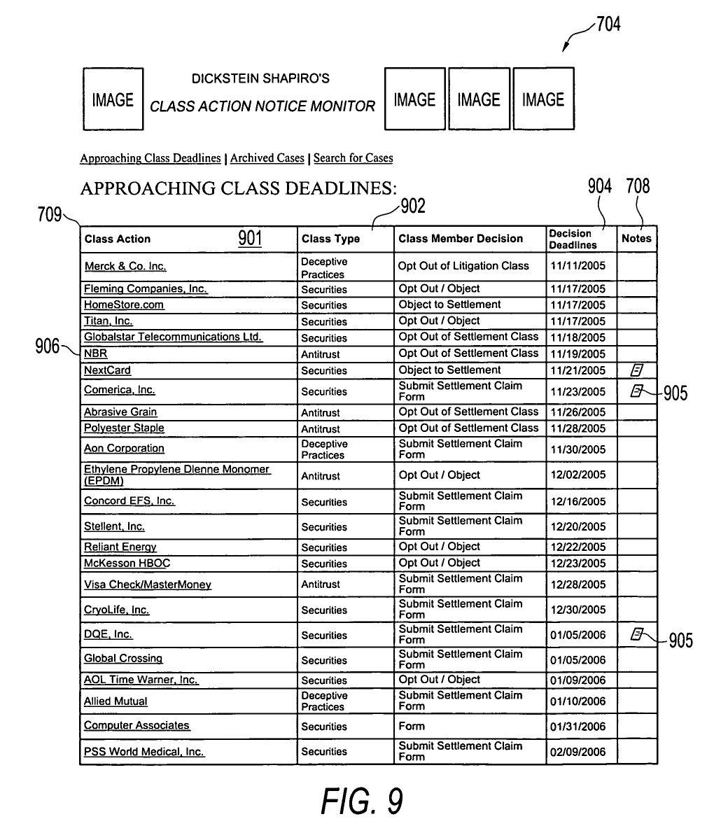

FIG. 9 is a screen view of an example of the approaching deadlines segment 704 user interface. As shown in FIGS. 7 and 9, in the approaching deadlines segment 704, the user 121 is provided with a class actions summary list 709 identifying deadlines by which class members must make a class member decision 903 that can modify or otherwise affect the rights of members of a defined class in a specified class action 901. The summary list 709 is arranged in table format, but could be arranged in other formats.

The summary list 709 provides the case name 901, the type of class action 902, the next decision 903 that is required by class members and the deadline 904 for the decision. There is also a notes segment 708, through which the user 121 can add notes associated with a class action. The notes are stored in the database 102. If the user 121 has added notes associated with a class action, a notes icon 905 is associated with the notes segment 708 for that class action in the summary list 709.

As noted above, where multiple users 121 have access to the system 100 via the Web site 150, the user login information serves to define what data a particular user 121 can access. For example, where multiple users 121 have entered notes associated with the same class action, the login information can be used to determine which notes a particular user 121 can access and can prevent the user 121 from accessing other users' 121 notes. Additionally, the system 100 can be configured so that a group of users 121 has access to certain information in the database 102, but not other information.

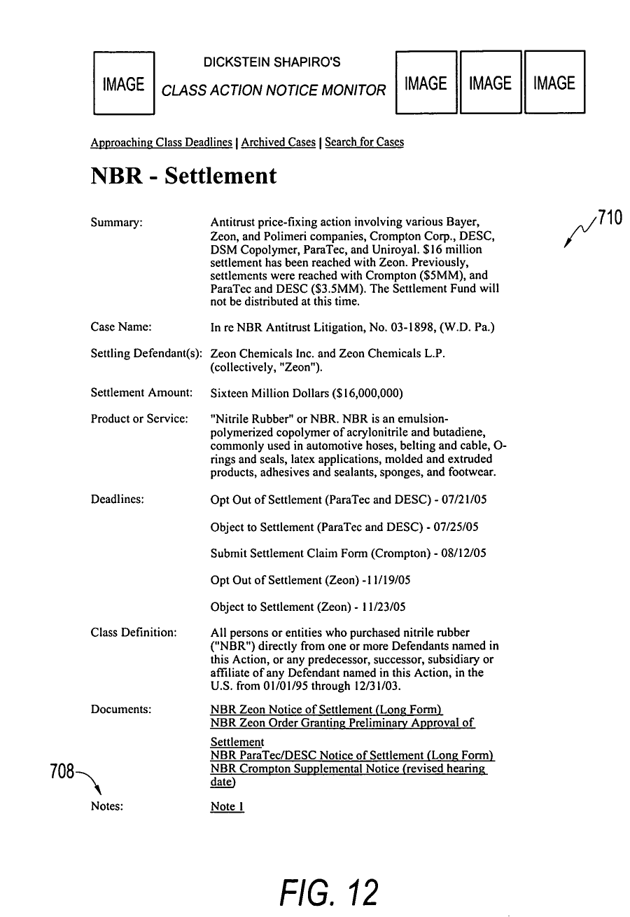

The summary list 709 is an interactive user interface that allows the user 121 to further navigate within the Web site 150. By selecting a notes icon 905 within the notes segment 708 for a class action 901, the user can view, delete or add notes associated with the respective class action. By selecting a particular class action from the summary list 709, the user is taken to a class action details segment 710 for the selected class action (FIG. 12). For example, by selecting the NBR class action 906, the user is taken to a details segment 710 that provides detailed information about the NBR class action 906.

FIG. 12 is an exemplary illustration of a screen display of the class action details segment 710 user interface for the NBR class action 906. The FIG. 12 details segment 710 provides the data gathered by the monitoring module 170 and stored in the database 102 related to the NBR class action 906. The details segment 710 provides a summary of the class action, the case name, the product or service at issue in the class action, a decisions that need to be made and the deadlines for those decisions, the class definition and selected documents associated with the case (e.g., proof of claim forms, settlement agreements, court notices). The documents can be selected as desired, and preferably include at least all notices provided in the class action. As the details segment 710 is an interactive user interface, the user 121 can access, view and copy a complete version of each document by selecting the document. Additionally, the user 121 can add, delete and view the notes 708 associated with the class action 906 by selecting the notes. Where no notes have been added to a class action, an “add notes” link appears to allow the user 121 to add initial notes to the class action.

If a defendant in the NBR class action 906 has settled, the details segment 710 provides the name of the settling defendant(s) and the settlement amount. As new data related to the NBR class action 906 is stored in the database 102, the details segment 710 changes accordingly.

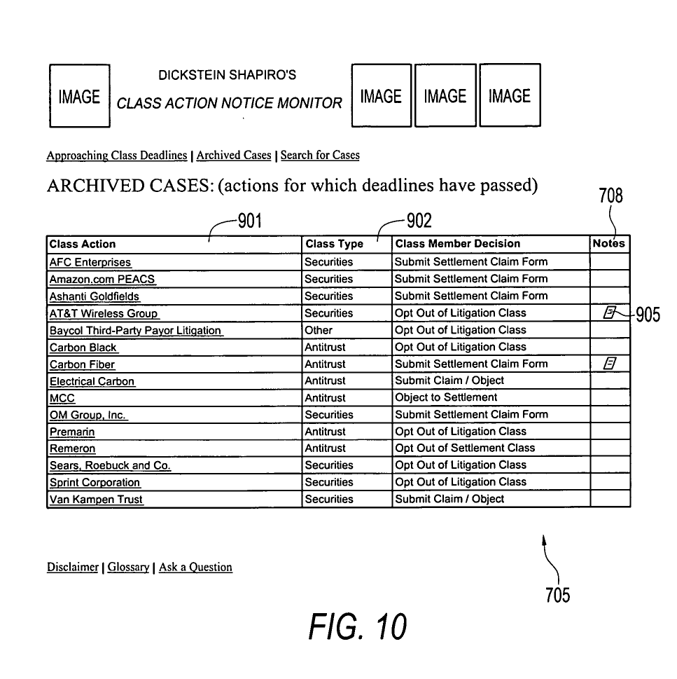

Referring again to FIG. 7, the archived cases segment 705 allows a user to access class actions for which deadlines have passed and there are no known approaching deadlines. A summary list 709 is also provided for the archived cases segment 705. FIG. 10 is a screen shot of the archived cases segment 705 user interface including the summary list 709. The summary list 709 shown in FIG. 10 is similar to the summary list 709 shown in FIG. 9, except that it lists only archived cases. Accordingly, no deadlines are shown and the class member decision 903 displayed is the last decision that the court asked class members to make in the class action 901. The user 121 can select a details segment 710 for any of the listed class actions, and add, delete or view any notes associated with any of the listed class actions, as well as use the interactive user interface, among other things, to view and print copies of pertinent documents displayed in the details segment 710.

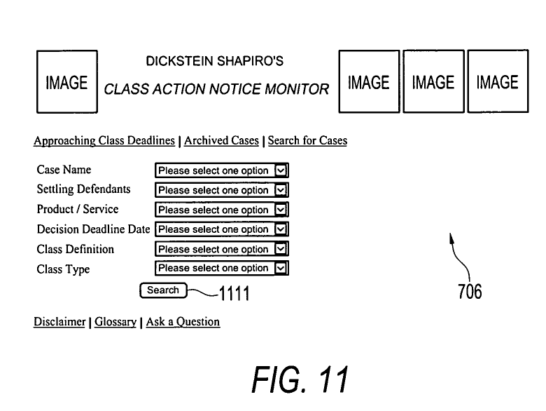

Referring to FIG. 7, the search segment 706 of the Web site 150 enables a user to search for a class action that meets user defined criteria. FIG. 11 is a screen shot of the search segment 706 user interface. As shown in FIG. 11, in the illustrated embodiment, the user 121 can search for class actions based on any one or more of the following: case name, settling defendants, product and/or services, decision deadline date, class definition and/or class type. The search segment 706 can instead be configured to allow the user 121 to search data stored in the database 102 based on other criteria or to conduct a natural language or Boolean-type search as is known in the art.

Once the user 121 has entered search criteria and selected the search button 1111, the system 100 searches the database 102 for class actions meeting the one or more entered search criteria, those class actions are listed. The user 121 can select a particular class action and access a class action details segment 710 for the selected class action, and add, delete or view any notes associated with the selected class action.

Referring again to FIG. 7, the class actions of interest segment 707 allows a user to access class actions of interest to the particular user. When the user 121 accesses to class actions of interest segment 707, the system 100 produces a report according to the method described above in connection with FIG. 5. The system 100 applies the user data for the user 121 based on the login information entered by the user 121. In the illustrated embodiment, the report is presented to the user 121 in the segment 707 as a summary list 709. The summary list 709 presented in the class actions of interest segment 707 is similar to the summary list 709 shown in FIG. 9, except that only class actions meeting the user data criteria are listed. Accordingly, the user 121 can select a particular class action and access a class action details segment 710 for the selected class action, and add, delete or view any notes associated with the selected class action.

Referring again to FIG. 7, when the user 121 accesses the in-the-news segment 703, the user 121 is presented with data regarding new class actions, and, if desired, data regarding potential class actions. The information provided by the in-the-news segment 703 is similar to that provided in the news watch 603 shown in FIG. 6. Thus, the user 121 is provided general information on class actions that have yet to be settled or certified for class purposes, as well as matters (e.g., government investigations) for which class actions may be filed.

It should be readily understood that the present invention can be modified in the manners set forth herein as well as to any number of variations, alterations, substitutions or equivalent arrangements not heretofore described, but which are commensurate with the spirit and scope of the invention in order to obtain a desired memory functionality.

What is claimed as new and desired to be protected by Letters Patent of the United States is:

1. A method for monitoring class actions comprising:
providing a plurality of sources potentially containing data related to at least one class action;
selecting a set of criteria configured to select class action data related to the at least one class action from the plurality of sources;
applying the set of criteria to the data contained in the sources;
storing class action data meeting the set of criteria in a storage device;
providing a user interface through which the user can access to the stored class action data.

2. The method of claim 1 wherein providing the user interface comprises providing a Web site.

3. The method of claim 1, wherein storing the class action data comprises storing at least one deadline for a class action.

4. The method of claim 3, further comprising, automatically notifying the user of the at least one deadline.

5. The method of claim 1, wherein monitoring the sources comprises monitoring at least one source from the group consisting of: an Internet-based legal news publication, an on-line newspaper, a claims administrator's Web site, and a plaintiff's bar Web site.

6. The method of claim 2, further comprising receiving input from the user

7. The method of claim 1, further comprising:
receiving user data, the user data comprising information about the user;
comparing the user data to the class action data; and
determining whether the at least one class action is of interest to the user based on the similarities between the user data and the class action data.

8. The method of claim 7, further comprising, if the at least one class action is determined to be of interest to the user, notifying the user of the at least one class action.

9. The method of claim 7, wherein the user data comprises information about products or services used by the user.

10. The method of claim 9, wherein the class action data comprises the class definition.

11. A system for monitoring class actions, the system comprising:
at least one server;
at least one storage device in communication with the at least one server;
a monitoring module for monitoring a plurality of sources potentially containing data related to at least one class action, applying a set of criteria to the data contained in the plurality of sources, the set of criteria configured to select for information related to at least one class action from the plurality of sources, and storing class action data meeting the set of criteria in a storage device; and
a Web site on the at least one server for providing a user interface through which a user can access the class action data.

12. The system of claim 11, further comprising a notification module for automatically notifying the user of the data related to the at least one class action stored in the at least one storage device.

13. The system of claim 12, wherein the set of criteria are configured to select for deadlines in class actions and wherein the notification module is configured to automatically notify the user of the deadlines.

14. The system of claim 11, wherein the monitoring module is further configured to receive user data, the user data comprising information about the user, compare the user data to the class action data, and determine whether the at least one class action is of interest to the user based on the similarities between the user data and the class action data.
A computer software program product for monitoring class actions embodied on a computer useable medium, comprising:
a monitoring application that runs on a server in communication with a computer network and is configured to monitor a plurality of sources potentially containing data related to at least one class action, apply a set of criteria to the data contained in the plurality of sources, the set of criteria configured to select for information related to at least one class action from the plurality of sources, and store class action data meeting the set of criteria in a storage device; and
a notification application that runs on the server and is configured to automatically notify the user of the class data related to the at least one class action stored in the storage device.

15. The product of claim 15, further comprising a user interface application that provides the user a user interface from which the user can access the class action data.

16. The product of claim 15, wherein the monitoring module is further configured to receive user data, the user data comprising information about the user, compare the user data to the class action data, and determine whether a class action is of interest to the user based on the similarities between the user data and the class action data.

17. The product of claim 17, wherein the notification module is further configured to, if the at least one class action is determined to be of interest to the user, notify the user of the class action of interest.
